(19) United States
(12) Patent Application Publication
(10) Pub. No.: US 2017/0325630 A1
(43) Pub. Date: Nov. 16, 2017

(54) BAKE SYSTEM

(71) Applicant: HSIU-CHI LIN, Taipei City (TW)

(72) Inventor: HSIU-CHI LIN, Taipei City (TW)

(21) Appl. No.: 15/153,731

(22) Filed: May 12, 2016

(51) Int. Cl. A47J 37/01; A47J 36/00

(52) U.S. Cl. CPC A47J 37/015; A47J 36/00

(57) ABSTRACT

A bake system comprises a baking unit for supporting object to be baked, and heating the object to be baked; a weight sensor for measuring weight of the object to be baked on the baking unit; the measurement being continuously performed in the baking process and outputting measuring values; and an operation unit receiving predetermined number of data from the converting unit and averaging the data continuously received from the converting unit for reduction of errors. The bake system detects the baking levels of the object to be baked by detection of the variations of the baking object in the baking proves. Therefore in the baking process, the heating temperature, time periods and other factors are controlled for getting final products with desired baking levels.

### FIELD OF THE INVENTION

The present invention relates to bake systems, in particular to a bake system with a well control module by using weight of the object to be baked as a control feature.

### BACKGROUND OF THE INVENTION

In current bake system, such as devices for baking coffee beans, the qualities of the baking objects are determined mostly by the colors or odors or of the surfaces or sounds of the baking materials. Furthermore, ways for controlling the baking levels are determining by temperatures and other related features. However, all these processes rely people to monitor these features, while current baking devices only set some simple states for monitoring the baking levels which is inelastic and imprecise so that the kinds of the produces are confined and precise of the qualities are also limited.

### SUMMARY OF THE INVENTION

Accordingly, object of the present invention is to provide a bake system which can detect the baking levels of the object to be baked by detection of the variations of the baking object in the baking proves. Therefore in the baking process, the heating temperature, time periods and other factors are controlled for getting final products with desired baking levels.

To achieve above object, the present invention provides a A bake system, comprising: a baking unit for supporting object to be baked, and heating the object to be baked; a weight sensor for measuring weight of the object to be baked on the baking unit; the measurement being continuously performed in the baking process and outputting measuring values; an operation unit receiving predetermined number of data from the converting unit and averaging the data continuously received from the converting unit for reduction of errors; a control unit receiving the average data from the operation unit, and then the average data being compared with setting values preset in the control unit; the comparing result being used to control the baking unit.

The bake system further comprises a signal converting unit for converting weight data output from the weight sensor to digital data which is provided to the operation unit. The weight sensor includes at least one load cell. The present number is ten. When the operation unit has accumulated ten weight data, an average is got; when three averages are got, the three averages are averaged again as a secondary average value.

### BRIEF DESCRIPTION OF THE DRAWINGS

FIG. 1 is a system block diagram of the present invention.

FIG. 2 is a flow diagram showing the method of baking in accordance to the present invention.

FIG. 3 shows another embodiment about the manufacturing process of the present invention, in that a relation between the weight of an object to be baked in the process and time is shown.

FIG. 4 shows another embodiment about the manufacturing process of the present invention, in that a relation between weight of an object to be baked in the process and time is shown.

### BRIEF DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

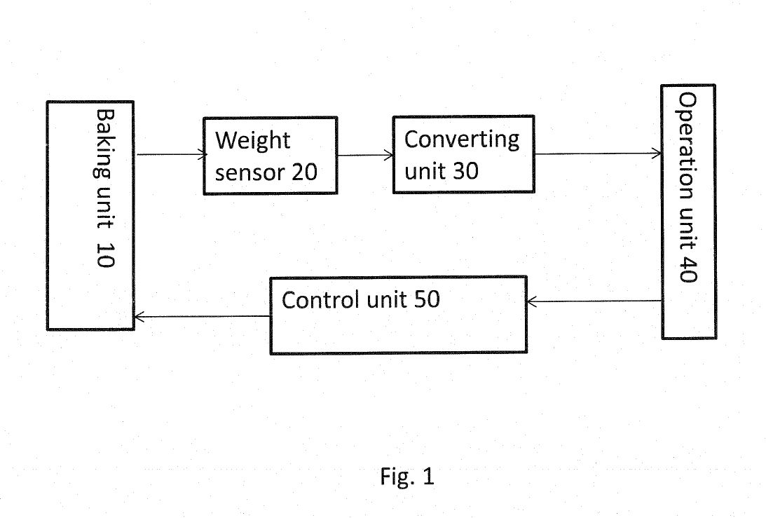

With reference to FIG. 1, the bake system of the present invention is illustrated. The bake system of the present invention include s the following elements.

A baking unit 10 includes a furnace and a heating element (not shown) for supporting object to be baked, such as coffee beans, or peanuts, etc. The heating elements serve to heat the object in the furnace

A weight sensor 20 serves to measure the weight of the object to be baked on the baking unit 10. The measurement is continuously performed in the baking process and output the measuring values which are analog data.

A converting unit 30 serves to convert the analog data from the weight sensor into digital data. The digital data are transferred out.

An operation unit 40 receives the digital data from the converting unit 30 and averages the digital data continuously received from the converting unit 30 for reduction of errors, such as an error of ±1 gram. Therefore, when the digital data from the converting unit 30 are accumulated from a predetermined number, the data will be averaged for reduction of the errors.

A control unit 50 receives the average data from the operation unit 40, and then the average data is compared with setting values preset in the control unit 50. If the average value is larger than the setting value. The control unit 50 will control the baking unit 10 to heat the object to be baked continuously. If the average value is smaller than the setting value, the control unit 50 will control the baking unit 10 to stop to heat the object to be baked and control to take out the object to be baked and to cool it so as to complete the whole baking operation.

In this embodiment, the weight sensor 20 may be a load cell. The converting unit 30 may be an analog to digital converter (ADC). The operation unit 40 may be a microprocessor. The control unit 50 may be a microcontroller unit MCU). The setting values may be inputted by users and is changeable as required. When the operation unit 40 has accumulated ten weight data, an average is got. When three averages are received, the three averages are averaged again as a secondary average value.

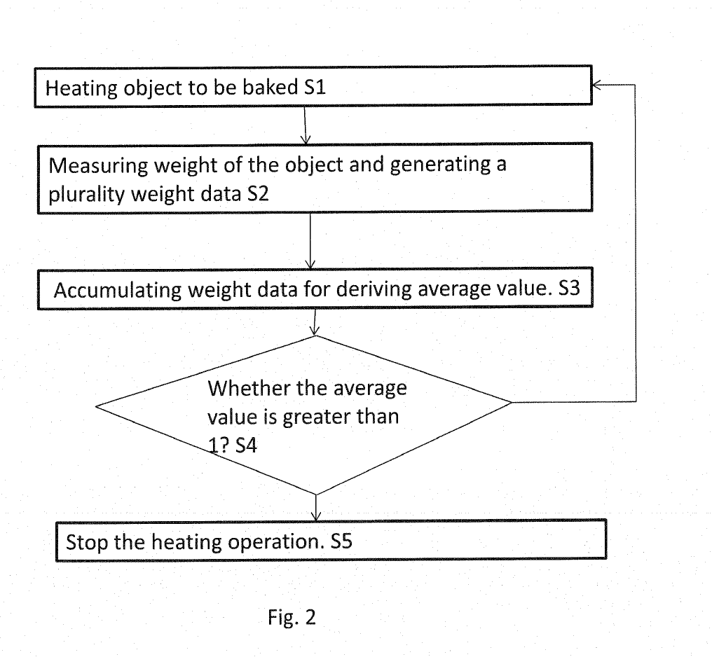

With reference to FIG. 2, in the baking method of the present invention, in step S1, an object to be baked is heated. In step S2, in the heating process, the weight of the object to be baked is measured many times so as to obtain several weight data. In step S3, when weight data of predetermined number is accumulated, they are averaged, for example, ten weight data are accumulated for cancelling external interferences, such as operations of transfer means. Then in step S4, the average data is compared with a setting value. If the average value is larger than the setting value, the process is returned to step S1 and the steps S1 to S3 are repeated. If the average value is smaller than the setting value, the process enters into step S5, the baking operation for the object to be baked is stopped and the object is cooled.

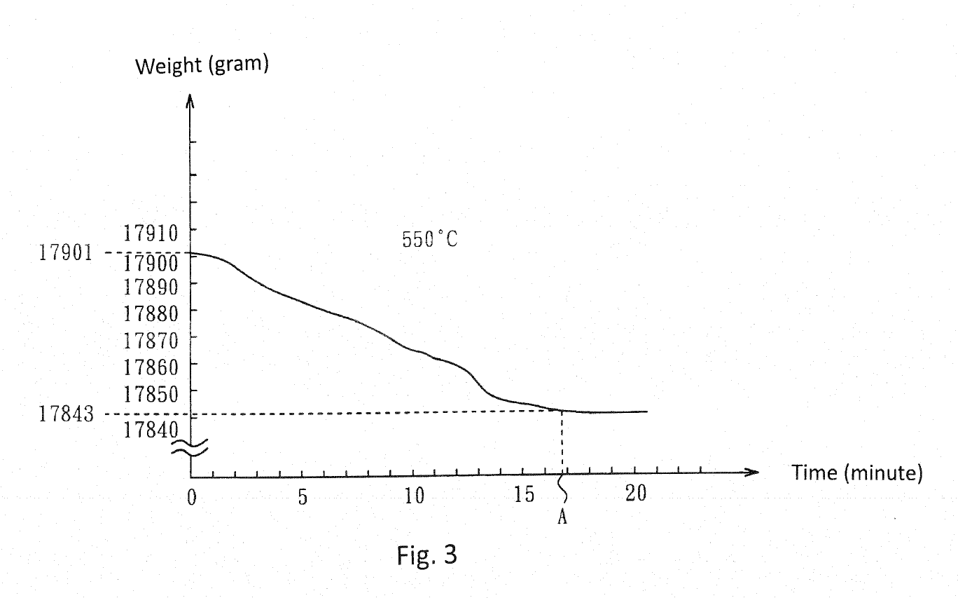

In one embodiment, the whole process is performed in a fixed temperature until the process is attained to a final setting value. For example, 352 grams of coffee beans are baked. If it desires that the final product of the object to be baked has a weight loss of 16.5%. Then the upper setting value is 83.5% (that is to say that it plans that the final weight of the object to be baked is only 83.5% of the original weight). In the process, the object to be baked is heated under a temperature of 550° C. until the weight percentage of the object to be baked achieves to the predetermined value. With reference to FIG. 3, the relation of the weight to time of the object to be baked is illustrated. The longitudinal axis of the FIG. 3 represents weight of the object to be baked and the transversal axis represents heating time. In this embodiment, the weight of the object to be baked is 352 grams and above setting value is 83.5%. This is, it desires that the final weight of the object to be baked is 294 grams, while the weight of the furnace is 17594 grams. Therefore the weight measured by the weight sensor 20 is reduced to 17843 grams from 17901 grams. The point A in the transversal axis represents that the weight has achieved the setting value and thus the process for baking is ended.

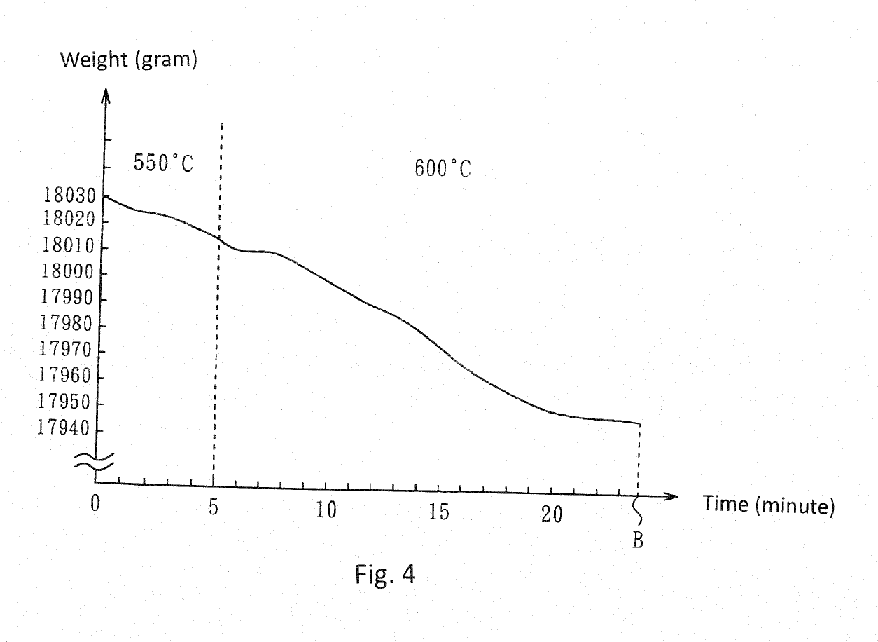

In another embodiment, variable temperature is used in heating through a predetermined time period and then another temperature is used to heat the object to be baked to a preset value. For example, the object to be baked is coffee beans of 500 grams which is heated under 550 degree C. through 5 minutes. Then the temperature is adjusted to 600 degree C. until the percentage is achieved to 83.5% . Referring to FIG. 4, a relation between the object to be baked and weight is illustrated. In this embodiment, the object to be baked is 500 grams and the setting value is 83.5%. That is, the final weight of the object is 417.5 grams and the weight of the furnace is still 17459 gram. Therefore the weight measured by the weight sensor is reduced to 17948 from 18030 grams. At the initial five minutes, the heating temperature is 550 degrees. The heating temperature increases to 600 degrees C. from the five minutes. Then the temperature is retained at 600 degree C. The transversal axis represents the heating time and the point B in the axis represents the timing to end baking process.

Furthermore, in another embodiment, other than the setting value, another middle value can be set. When the average is equal to or smaller than the middle value, the heating temperature is changed so as to satisfy different requirement in baking. For example, for the above setting of 83.5%, a middle value of 90% can be set for changing of baking temperature. When the unit 10 is heated at 550 degree C., the weight sensor 20 detects the weight of the baking object continuously until the weight thereof is reduced to 90% of the original weight. Then the temperature is changed, for example, it is increased to 600 degree C. until it achieves the final 83.5%. Therefore final products of different qualities can be produced.

In the bake system and method of the present invention, the weight of the object to be baked is detected for determining the baking level of the object to be baked. In the baking process, the heating temperature, time and other factors are controlled for getting the final products as required. Therefore various kinds of products can be produced by the method provided in the present invention. The products could by made massively with identical quality.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A bake system, comprising:
a baking unit for supporting object to be baked, and heating the object to be baked;
a weight sensor for measuring weight of the object to be baked on the baking unit; the measurement being continuously performed in the baking process and outputting measuring values; and
an operation unit receiving predetermined number of data from the converting unit and averaging the data continuously received from the converting unit for reduction of errors;
a control unit receiving the average data from the operation unit, and then the average data being compared with setting values preset in the control unit; the comparing result being used to control the baking unit.

2. The bake system as claimed in claim 1, further comprising a signal converting unit for converting weight data output from the weight sensor to digital data which is provided to the operation unit.

3. The bake system as claimed in claim 1, wherein the weight sensor includes at least one load cell.

4. The bake system as claimed in claim 1, wherein the present number is ten.

5. The bake system as claimed in claim 1, wherein when the operation unit has accumulated ten weight data, an average is got; when three averages are got, the three averages are averaged again as a secondary average value.
